(19) United States
(12) Patent Application Publication
(10) Pub. No.: US 2023/0062539 A1
(43) Pub. Date: Mar. 2, 2023

(54) COMPOSITE PANE FOR A VEHICLE WITH INTEGRATED RADAR SENSOR

(71) Applicant: SAINT-GOBAIN GLASS FRANCE, COURBEVOIE (FR)

(72) Inventors: Stephan GILLESSEN, ALSDORF (DE); Marcel KLEIN, BAESWEILER (DE); Valentin SCHULZ, NIEDERZIER (DE); Robert BESLER, HERZOGENRATH (DE)

(21) Appl. No.: 17/792,929

(22) PCT Filed: Jan. 7, 2021
(86) PCT No.: PCT/EP2021/050148

§ 371 Date: Jul. 14, 2022

(30) Foreign Application Priority Data
Jan. 15, 2020 (EP) 20151969.1

(51) Int. Cl. G01S 7/02; G01S 13/931; H01Q 1/12; H01Q 1/32; B32B 17/10; B32B 3/08

(52) U.S. Cl. CPC G01S 7/028; G01S 13/931; H01Q 1/1271; H01Q 1/3275; H01Q 1/3233; B32B 17/10036; B32B 3/08; B32B 17/10761; B32B 17/10788; B32B 17/1077; B32B 17/10339; B32B 17/10807; B32B 17/10293; G01S 2013/93273; G01S 2013/93276; B32B 2605/006

(57) ABSTRACT

A composite pane for a vehicle with an outer pane and an inner pane that are joined to one another via a thermoplastic intermediate layer and the composite pane is provided for separation of a vehicle interior for occupants from an external environment, wherein at least one radar sensor is integrated into the thermoplastic intermediate layer and is designed and arranged such that the radar sensor emits radar beams into the vehicle interior and receives reflected radar beams, and the radar sensor is connected to an evaluation unit for determining movement and/or presence of persons or animals in the vehicle interior.

The invention relates to a composite pane for a vehicle with an integrated radar sensor and a method for its production and its use.

Modern vehicles are now developed for the highest possible efficiency and optimum occupant safety and are equipped with a variety of driver assistance systems. These include, for example, rain sensors, daylight sensors, backlight sensors, ultrasonic sensors, optical cameras, and radar sensors. They are generally used for traffic monitoring and can, for example, recognize road signs or detect the position and speed of objects outside the vehicle, such as other road users or obstacles situated on the roadway. Currently, optical cameras or radar systems are predominantly used for this purpose.

Currently, camera systems such as, for example, infrared camera systems are used primarily for monitoring the vehicle interior, for example, for driver monitoring, gesture recognition, and fatigue detection. The facial area of a person, for example, of the driver, can be searched by a camera and monitored. From the images recorded, the eye region (eye open/closed) can then be separated and evaluated. Conclusions about the state of fatigue can then be drawn from the frequency of eyelid closure. However, the function and data quality of optical sensor systems are usually highly dependent on environmental influences and ambient brightness; camera systems must also be precisely aligned and need an unobstructed “look” at the detection area. In principle, a camera can detect and determine persons and their position in the vehicle interior. However, a child in a child seat who is to be protected against the sun with a cloth may not be detected through the covering. With infrared cameras, it is possible to distinguish people from objects in the vehicle interior, i.e., for example, a child in a child seat and an empty child seat.

If children or animals are left behind in a locked vehicle when the sun is shining, critical health conditions or even death due to overheating can occur very quickly. In the United States alone, in the year 2018, more than 50 children left in cars died from overheating. However, the image and data quality of infrared cameras, which have been used to date for monitoring, are very negatively affected by solar radiation and heated interiors such that reliable monitoring and evaluation cannot be provided under certain conditions. In addition, the computational outlay in the evaluation of the data is very high.

The object of the invention is, consequently, to provide a composite pane for a vehicle with an improved safety function for the vehicle interior and persons situated therein that is also economical and easy to produce.

These and other objects are accomplished according to the proposal of the invention by a composite pane in accordance with the independent claim. Advantageous embodiments of the invention are apparent from the dependent claims.

The invention relates to a composite pane for a vehicle with an outer pane and an inner pane that are joined to one another via a thermoplastic intermediate layer and the composite pane is provided for separation of a vehicle interior for occupants from an external environment, wherein at least one radar sensor is integrated into the thermoplastic intermediate layer and is designed and arranged such that the radar sensor emits radar beams into the vehicle interior and receives reflected radar beams, and the radar sensor is connected to an evaluation unit for determining movement and/or presence of persons or animals in the vehicle interior.

The integration of at least one radar sensor into a composite pane according to the invention advantageously enables providing reliable monitoring of the vehicle interior or of persons and/or animals in the vehicle interior. Advantageously, the radar sensor or the determination of the radar data is possible even in the case of darkness or strong sunlight and heat. In addition, persons and animals covered by textiles and their movements can also be easily detected and monitored. The radar sensor is integrated into the thermoplastic intermediate layer and thus encapsulated by it, secured, and protected against environmental influences. Advantageously, the radar signals can penetrate glass and plastics and are also insensitive to vibrations. The evaluation of the data received is then performed by the evaluation unit connected to the radar sensor.

In principle, all electrically insulating substances that are thermally and chemically stable as well as dimensionally stable under the conditions of the production and use of the composite pane according to the invention are suitable as the outer pane and the inner pane.

The terms “outer pane” and “inner pane” are selected merely to distinguish between the two panes in a composite pane according to the invention. The terms do not imply any statement concerning the geometric arrangement. When the composite pane according to the invention is provided, for example, in an opening, for example, of a vehicle or a building, to separate the interior from the external environment, the outer pane usually faces the exterior environment, whereas the inner pane faces the interior.

The panes preferably contain or are made of glass, particularly preferably flat glass, most particularly preferably float glass, such as soda lime glass, borosilicate glass, or quartz glass. Alternatively, the panes can contain or be made of clear plastics, preferably rigid clear plastics, in particular polyethylene, polypropylene, polycarbonate, polymethyl methacrylate, polystyrene, polyamide, polyester, polyvinyl chloride, and/or mixtures thereof. The panes are preferably transparent, in particular for use of the panes as a windshield or rear windows of the vehicle or other uses where high light transmittance is desired. In the context of the invention, “transparent” then means a pane that has transmittance greater than 70% in the visible spectral range. For panes that are not located in the traffic-relevant field of vision of the driver, for example, for roof panels, the transmittance can, however, even be much lower, for example, greater than 5%.

The thickness of the panes can vary widely and thus be adapted to the requirements of the individual case. Preferably, standard thicknesses of the individual panes from 1.0 mm to 25 mm, for example, from 1.1 mm to 2.0 mm, preferably from 1.4 mm to 2.5 mm, for example, 1.6 mm or 2.1 mm, are used for vehicle glass. The size of the panes can vary widely and is governed by the size of the use according to the invention. The first pane and second pane have, for example, areas from 200 cm² up to 20 m², which are common in vehicle construction.

In one embodiment of the composite pane according to the invention, the thermoplastic intermediate layer is formed from one or a plurality of thermoplastic films. The thermoplastic intermediate layer preferably contains or is made of polyvinyl butyral (PVB), ethylene vinyl acetate (EVA), acoustic PVB, infrared radiation (IR) reflecting PVB, polyethylene, and/or polyurethane. The materials mentioned have proved to be particularly suitable in the production of composite panes. The thickness of each thermoplastic film is preferably from 0.2 mm to 2 mm, particularly preferably from 0.3 mm to 1 mm, in particular from 0.3 mm to 0.9 mm, for example, 0.38 mm, 0.51 mm, 0.78 mm, 0.81 mm or 0.86 mm. Such thermoplastic films are commercially available.

In another embodiment of the invention, the radar sensor is arranged embedded in the thermoplastic intermediate layer. According to the invention, the term “embedded” means that the material of the intermediate layer surrounds the radar sensor from all sides and surfaces. In other words, in this embodiment, the radar sensor is also surrounded in a sandwich-like manner by thermoplastic material of the intermediate layer. As a result, the radar sensor can, for one thing, be protected against environmental influences, such as moisture, but also against vibrations. Furthermore, in this embodiment, the radar sensor is also connected and securely attached to the inner pane and the outer pane via the material of the intermediate layer. The visual appearance of the composite pane can also possibly be further improved by this design.

In another embodiment, provision is made for the radar sensor in the composite pane according to the invention to be visually masked by a black or white print and/or by stickers on the outer pane and/or on the inner pane. The masking can be applied on the outside surface of the outer pane I, on the inside surface of the outer pane II, the inside surface of the inner pane III, and/or on the outside surface of the inner pane IV. As a result, the visual appearance of the composite pane can be improved. The masking can be applied or implemented in the same way that is customary, for example, when providing customary edge masking by means of a black or white print that conceals the connecting leads. The masking can, for example, be applied to the inner pane and/or the outer pane by screen-printing. Advantageously, the function of the radar sensor is not impaired or influenced by such masking.

In accordance with another embodiment of the invention, the radar sensor for receiving radar data can be operated with a frequency bandwidth of at least 2 GHz; for example, of 4, 6, 8 or 10 GHz, and/or a frequency band of 76 to 150 GHz. For example, the radar sensor can be operated in a frequency band of 76 to 140 GHz, 76 to 120 GHz. In an exemplary embodiment, the radar sensor can be operated over a frequency bandwidth of 10 GHz around 140 GHz.

In another embodiment of the composite pane according to the invention, the radar sensor preferably has a detection range from 30 cm to 10 m. The small range intended according to the invention that is to comprise the vehicle interior enables keeping the transmitting power and the size of the radar sensors and antennas small as well. On the one hand, this facilitates the integration of the radar sensor into the composite pane according to the invention and, on the other, also enables energy-efficient operation of the radar sensors.

In another embodiment of the composite pane according to the invention, the radar sensor has a thickness of preferably less than 1 mm, particularly preferably of less than 0.5 mm. “Thickness” means, in other words, the height of the radar sensor. Expediently, the height of the radar sensor is selected such that it can be easily integrated into the intermediate layer of the composite glass pane. For example, the dimensions of the radar sensor could be 5 cm×5 cm×0.75 mm (length×width×thickness). The size, in terms of the sensor area, i.e., the length and the width of the radar sensor used is, in principle, not critical, although miniaturization is always sought, if only for aesthetic reasons. The integration of the radar sensor into the composite pane can be achieved easily due to the already possible small dimensions of already available radar sensors and radar sensors systems. Advantageously, the radar signals can penetrate glass and plastics and are insensitive to vibrations.

In another embodiment, the radar sensor has a semiconductor chip that implements at least one radar transceiver. Examples of such radar sensors are single-chip systems implemented in FMCW radar technology, for example, 77 GHz or 140 GHz single-chip radar sensors. With such radar sensors, it is particularly readily possible to detect not only large movements, such as gestures, but also vital functions, such as heartbeat or breathing of persons as well as their presence in the vehicle interior; and the dimensions of such sensor systems are advantageously designed to be particularly compact and small, which further facilitates integration into the intermediate layer of a composite pane.

The semiconductor chip can, according to the invention, also additionally implement a digital signal processing component and/or a control unit of the radar sensor. Alternatively, or additionally, the semiconductor chip and an antenna assembly of the radar sensor can be implemented as a package and integrated into the intermediate layer. Advantageously, very compact CMOS radar sensors on semiconductor chips, so-called “radar-on-chip-systems” with on-chip memories, signal processing components, microcontrollers, for processing the radar signals, and/or integrated antennas, which are particularly compact and particularly suitable for the short range application in the vehicle interior, are already available. The additional integration of the antennas ensures short signal paths and a lower signal-to-noise ratio and is suitable for high frequencies and relatively large and variable frequency bandwidths.

In another embodiment, the radar sensor and/or the evaluation unit is connected to the onboard electronics and/or to a warning system of the vehicle or to an external output device for outputting a warning signal. Thus, for example, upon detection of the presence of a child in an otherwise unoccupied vehicle, an alarm system of the vehicle can output an acoustic and/or visual signal. A different or additional possibility would be linkage to an automatic emergency system eCall. This ensures timely intervention.

In another embodiment, provision is made for the composite pane, in particular the intermediate layer, to include at least one more sensor, for example, one or a plurality of radar sensors, and/or at least one more functional element. This can, on the one hand, enable additional functions, such as burglary protection, vehicle monitoring, or driving assistance. In addition, for example, one or a plurality of cameras or other sensors with additional functions can be integrated into the composite pane. In particular, however, it is possible to also provide additional sensors or functional elements that additionally support the safety function of the radar sensor and/or are, optionally, functionally connected thereto or interact therewith. This can be done, for example, by one or a plurality of additional radar sensors that are, for example, connected to one another via a CAN bus system and operated simultaneously in such a CAN network. The radar data of the various sensors can then be processed and evaluated together, further increasing the accuracy and reliability of the resulting measurement data.

The invention further relates to a method for producing a composite pane as described above, comprising the steps
Providing a stack sequence composed of an outer pane, an inner pane, and at least one thermoplastic film arranged therebetween for forming the thermoplastic intermediate layer,
wherein at least one thermoplastic film includes at least one radar sensor or a radar sensor (4) is arranged between the thermoplastic film and the outer pane (1) and/or the inner pane (2),
Laminating the stack sequence to form a composite pane (100).

In other words, according to the invention, an outer pane, an inner pane, and the at least one thermoplastic film arranged therebetween and the at least one radar sensor can be arranged as a stack. The radar sensor can be laminarly adjacent the outer pane and/or the inner pane. The two panes and the film arranged therebetween are naturally arranged one atop the other laminarly and substantially congruently. The radar sensor is expediently positioned within the pane surfaces such that, in the installed state, it has the desired detection range in the resulting composite pane. Preferably, before lamination, the radar sensor is provided, for example, with a flat conductor, possibly with all the desired electrical or electronic connections. These connections and leads can be produced and provided in a known, customary manner.

The laminating and thus the joining of formed layer sequences to form the composite pane are preferably done under the action of heat, vacuum, and/or pressure. Methods for producing a composite pane known per se can be used. During lamination, the heated, flowable thermoplastic material flows into the spaces and around the radar sensor such that a stable bond is produced and the radar sensor is encapsulated in the intermediate layer and secured in the intermediate layer.

For example, so-called “autoclave methods” can be carried out at an elevated pressure of approx. 10 bar to 15 bar and temperatures from 130° C. to 145° C. for approx. 2 hours. Vacuum bag or vacuum ring methods known per se operate, for example, at approx. 200 mbar and 80° C. to 110° C. The outer pane, the thermoplastic intermediate layer, and the inner pane can also be pressed in a calender between at least one pair of rollers to form a pane. Systems of this type are known for the production of panes and usually have at least one heating tunnel upstream of a pressing unit. The temperature during the pressing operation is, for example, from 40° C. to 150° C. Combinations of calendering and autoclaving methods have proved particularly effective in practice. Alternatively, vacuum laminators can be used. These consist of one or a plurality of heatable, evacuable chambers, in which the panes are laminated within, for example, approx. 60 minutes at reduced pressures of 0.01 mbar to 800 mbar and temperatures of 80° C. to 170° C.

In one embodiment of the method, the radar sensor can be inserted form-fittingly into a cutout in at least one thermoplastic film of the thermoplastic intermediate layer. The thermoplastic layer can be formed by a continuous thermoplastic film into which cutouts, for example, are or will be introduced by cutting or punching, into which the radar sensor can be inserted or placed. The thermoplastic layer is, in other words, then implemented like a frame around the radar sensor. Alternatively, the thermoplastic film of a layer can also be composed of a plurality of film sections arranged around the radar sensor. The thermoplastic layer thus formed continuously or from subsections is preferably roughly adapted in its thickness to the height (thickness) of the radar sensor. Optical distortions or glass breakage during bonding can be largely avoided by the compensation of the thickness thus implemented.

It is likewise also possible for the intermediate layer to be formed from multiple thermoplastic films and/or film sections arranged atop one another and for the cutout for receiving the radar sensor to be provided in two or more film layers positioned adjacent one another and directly atop one another. According to the invention, cutouts can be continuous holes through the thermoplastic layer or depressions within one or a plurality of films. During lamination, the thermoplastic layers thus arranged atop one another join together and form the intermediate layer. The film layers and/or film sections can be formed from the same or from different materials, such as PVB. It can therefore be the case that the different thermoplastic films and/or film sections fuse together uniformly and can no longer be distinguished from one another in the resulting composite pane.

The cutouts in the at least one thermoplastic film or in the film stack of multiple thermoplastic films are matched in size, position, and arrangement to the at least one radar sensor. This means that the dimensions of the cutouts essentially correspond to the dimensions of the radar sensor or are slightly larger, in particular are at most 150%, preferably at most 120% of the dimensions of the radar sensor. The position of the cutout corresponds to the desired positioning of the radar sensor in the composite pane to be manufactured. The associated cutout also fixes the radar sensor in the thermoplastic film or films during manufacture to form the intermediate layer. Additional fastening for sure and precise positioning during manufacture is not required.

The position of the radar sensor can be specified for production, which is advantageous in terms of mass production. Cutouts in the thermoplastic films can be created prior to lamination. Films with the defined cutouts can advantageously be prepared in advance in large quantities or even ordered to fit and obtained directly from the film supplier.

By providing an appropriately fitting cutout to receive the radar sensor in one or a plurality of thermoplastic films positioned atop one another, the height difference otherwise created is advantageously compensated, thus ensuring a low-stress connection in the resulting composite pane that is that is free of optical distortions. The thickness of the thermoplastic layer can be matched to the respective radar sensor used, to avoid, for example, glass breakage or stress in the outer and inner panes used due to a local difference in thickness, and also to produce an optically flawless connection.

In another embodiment of the method for producing a composite pane, the radar sensor can, for example, be connected to other sensors and/or to the onboard electronics via a CAN bus network.

The invention further extends to the use of the composite pane according to the invention in means of transport for traffic on land, in the air, or on water, in particular as a composite pane in motor vehicles, in particular as a roof panel or windshield.

The various embodiments of the invention can be implemented individually or in any combinations. In particular, the features mentioned above and to be explained in the following can be used not only in the combinations indicated but also in other combinations or in isolation without departing from the scope of the invention. Except where exemplary embodiments and/or their features are explicitly mentioned only as alternatives or are mutually exclusive.

In the following, the invention is presented in greater detail with reference to the figures. It should be noted that different aspects are described that can be used individually or in combination. In other words, any aspect can be used with different embodiments of the invention if not presented explicitly as a pure alternative

The drawings are simplified, schematic representations and are not to scale. The drawings in no way restrict the invention.

They depict

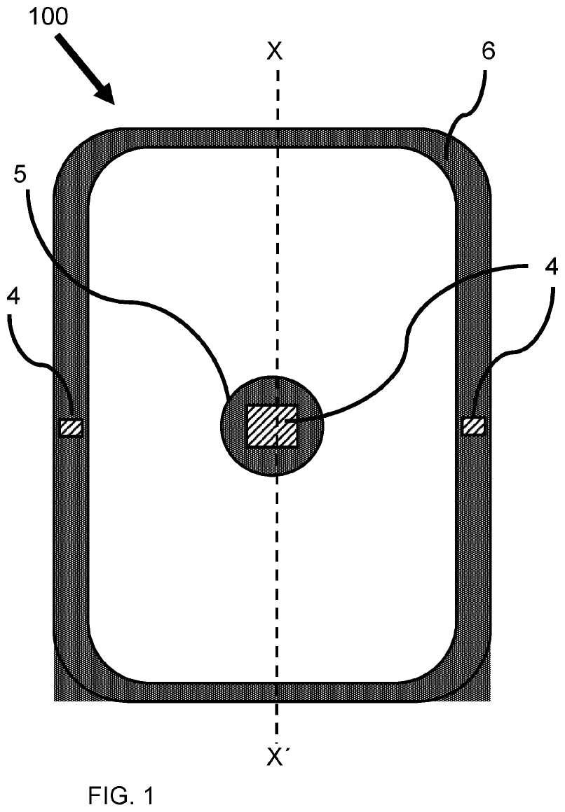

FIG. 1 a plan view of an embodiment of a composite pane according to the invention using the example of a roof panel of a vehicle,

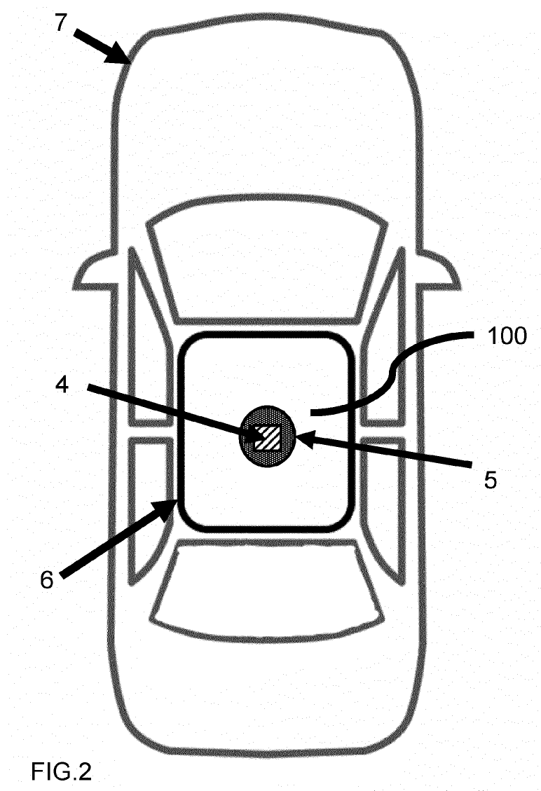

FIG. 2 a plan view of a roof panel of FIG. 1 installed in a vehicle;

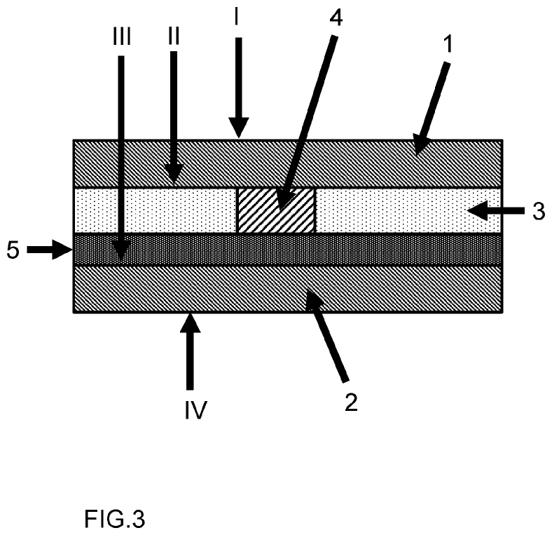

FIG. 3 a cross-sectional view of the composite pane along the section line X-X′ of FIG. 1,

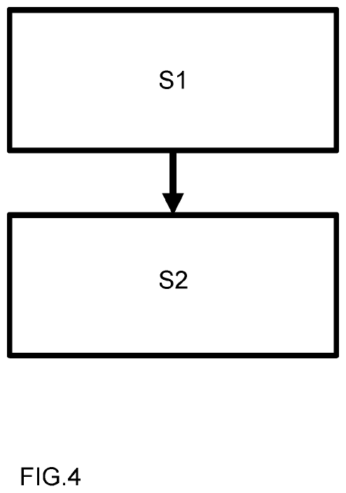

FIG. 4 a flow chart of an embodiment of the method according to the invention.

Also, for the sake of simplicity, in the following reference is generally always made to only one entity. However, unless explicitly noted, the invention can also have a plurality of the entities concerned. In this respect, the use of the words “a”, “an”, and “one” is to be understood only as an indication that in a simple embodiment, at least one entity is used.

FIG. 1 depicts a plan view of an embodiment of a composite pane 100 according to the invention, using the example of a roof panel for a vehicle. Expediently, a radar sensor 4 is arranged in an approx. central position of the roof panel 100 such that it has the largest possible detection range for receiving radar data. The radar sensor(s) 4 arranged in the composite pane 100 emit(s) radar beams into the vehicle interior and receive reflected radar beams. Electrical and electronic connections of the sensors are not shown. According to the invention, the radar sensor 4 is connected to an evaluation unit (not shown) for determining movement and/or presence of persons or animals in the vehicle interior. For example, multiple radar sensors 4 can be connected to one another via a CAN bus system and can be operated simultaneously in such a CAN network. The radar data of the various sensors can then be processed and analyzed together, thus further increasing the accuracy and reliability of the resultant measurement data and the safety function. In the embodiment depicted, the radar sensor 4 is optically concealed from the vehicle interior by masking 5. The masking 5 can, for example, be a black print that can be applied in the production process, for example, at the same time as the customary masking print 6 at the perimetral edge. The application of a masking print 6 is currently common and is used primarily to mask connectors and connections in and on the composite pane 100. A black print to implement the masking 5 of the radar sensor and the masking print 6 can, for example, be applied by screen-printing on the inside surface of the inner pane III or on the outside surface IV of the inner pane 2. The masking 5 can, alternatively, be done by arranging one or a plurality of stickers. The aesthetic impression is significantly increased by the masking 5 and also by the masking print 6. In the embodiment shown, two additional radar sensors 4 are arranged in the region of the masking print 6 at the perimetral edge of the composite pane 100. This already masks the radar sensors 4 such that no additional masking 5 needs to be applied in order to obtain a visually good impression of the composite pane. Additionally, or alternatively, further masking 5 of the radar sensor 4 could be implemented on the outer pane 1 in the same way, directed toward the outside.

In one embodiment, the radar sensor 4 and/or the evaluation unit is connected to the onboard electronics and/or to a warning system of the vehicle or to an external output device for outputting a warning signal. Thus, for example, upon detection of the presence of a child by the radar sensor 4 in an otherwise unoccupied vehicle, an acoustic and/or visual signal can be outputted by the alarm system of the vehicle. A different or additional possibility would be coupling to an automatic emergency call system eCall. Thus, timely intervention can be ensured.

FIG. 2 depicts a plan view of a composite pane 100 according to the invention installed in a vehicle (car) 7 as a roof panel of FIG. 1. The description of the composite pane corresponds to that of FIG. 1. The radar sensors 4 in the region of the masking print 6 at the perimetral edge of the composite pane 100 are not shown.

FIG. 3 depicts a cross-sectional view of the composite pane 100 along the section line X-X′ of FIG. 1. The embodiment shown depicts a composite pane 100 with an outer pane 1 and an inner pane 2 and, arranged therebetween, a thermoplastic intermediate layer 3, into which a radar sensor 4 is integrated. The radar sensor 4 is arranged in a cutout of the intermediate layer 3 and is laminarly adjacent the inside surface II of the outer pane 1. The radar sensor is thus encapsulated in the intermediate layer 3 and protected against environmental influences. The formed thickness of the intermediate layer 3 is adapted to the height (thickness) of the radar sensor 4 used. Optical distortions or glass breakage during lamination to form the composite pane 100 can be largely avoided by means of the compensation of the thickness thus implemented. Masking 5, which conceals the radar sensor 4 from the vehicle interior, is arranged on the inside surface III of the inner pane 2. This enables a visually appealing appearance of the composite pane 100. The radar sensor 4 preferably has a thickness of less than 1 mm, particularly preferably of less than 0.5 mm. For example, the dimensions of the radar sensor could be 3 cm×3 cm×0.5 mm (length×width×thickness). The size in terms of the sensor area, i.e., the length and the width of the radar sensor used is, in principle, not critical, although miniaturization is always strived for, if only for aesthetic reasons.

FIG. 4 depicts a flow chart of an embodiment of the method according to the invention. Production of a composite pane 100 as described above, comprising the steps
S1: Providing a stack sequence composed of an outer pane 1, an inner pane 2, and at least one thermoplastic film arranged therebetween for forming the thermoplastic intermediate layer 3,
wherein at least one thermoplastic film includes at least one radar sensor 4 or a radar sensor 4 is arranged between the thermoplastic film and the outer pane 1 and/or the inner pane 2,
S2: Laminating the stack sequence to form a composite pane 100.

In other words, according to the invention, in a first step S1, an outer pane 1, an inner pane 2, and the at least one thermoplastic film arranged therebetween for forming the intermediate layer 3, and the at least one radar sensor 4 are arranged and provided as a stack. The radar sensor 4 can be laminarly adjacent the outer pane 1 and/or the inner pane 2. The two panes 1 and 2 and the at least one thermoplastic film arranged therebetween are naturally arranged laminarly and essentially congruent atop one another. The radar sensor 4 is expediently positioned within the pane surfaces such that it has the desired detection range for receiving the radar data in the resulting composite pane 100 in the installed state. The radar sensors 4 according to the invention emit radar beams into the vehicle interior and receive reflected radar beams. According to the invention, the radar sensor 4 is connected to an evaluation unit (not shown) for determining movement and/or presence of persons or animals in the vehicle interior. Preferably, the radar sensor 4 is provided, prior to lamination, in step 2, for example, with a flat conductor possibly with all desired electrical or electronic connectors and contacts, for example, for connecting the radar sensor 4 to the evaluation unit and/or to the onboard electronics. The evaluation unit can, for example, integrated into the onboard electronics. Such connectors, contacts, and leads can be produced and provided in a known, customary manner, which need not be explained in detail.

The lamination and thus the joining of formed layer sequences to form the composite pane are preferably carried out under the action of heat, vacuum, and/or pressure. Methods known per se can be used to produce a composite pane. During lamination, the heated, flowable thermoplastic material flows into the spaces and around the radar sensor such that a stable bond is produced and the radar sensor is encapsulated and secured in the intermediate layer.

For example, so-called “autoclave methods” can be carried out at an elevated pressure of approx. 10 bar to 15 bar and temperatures from 130° C. to 145° C. for approx. 2 hours. Vacuum bag or vacuum ring methods known per se operate, for example, at approx. 200 mbar and 80° C. to 110° C. The outer pane, the thermoplastic intermediate layer, and the inner pane can also be pressed in a calender between at least one pair of rollers to form a pane. Systems of this type are known for the production of panes and usually have at least one heating tunnel upstream of a pressing unit. The temperature during the pressing operation is, for example, from 40° C. to 150° C. Combinations of calendering and autoclaving methods have proved particularly effective in practice. Alternatively, vacuum laminators can be used. These consist of one or a plurality of heatable, evacuable chambers, in which the panes are laminated within, for example, approx. 60 minutes at reduced pressures of 0.01 mbar to 800 mbar and temperatures of 80° C. to 170° C.

According to the invention, a composite pane is made available, with which the safety of occupants in in a vehicle can be further increased. In particular, even with environmental conditions unfavorable for other, optical systems, such as darkness or high heat and intense sunlight, reliable measurement and evaluation of data concerning movement and/or presence of persons or animals, are provided in a vehicle interior by the solution according to the invention with the integrated radar sensor. For example, children or animals left behind in an otherwise abandoned vehicle can be detected and a timely intervention can be made possible. Moreover, driver monitoring can also be further improved and reliably provided.

The production of a composite pane according to the invention with an integrated radar sensor can be carried out simply and economically and is suitable even for series production.

### LIST OF REFERENCE CHARACTERS

100 composite pane
1 outer pane
2 inner pane
3 intermediate layer
4 radar sensor
5 masking
6 masking print
7 vehicle
I outside surface of the outer pane
II inside surface of the outer pane
III inside surface of the inner pane
IV outside surface of the inner pane

1. A composite pane for a vehicle with an outer pane and an inner pane that are joined one another via a thermoplastic intermediate layer and the composite pane is provided for separation of a vehicle interior for occupants from an external environment, wherein at least one radar sensor is integrated into the thermoplastic intermediate layer and is designed and arranged such that the radar sensor emits radar beams into the vehicle interior and receives reflected radar beams, and the radar sensor is connected to an evaluation unit for determining movement and/or presence of persons or animals in the vehicle interior.

2. The composite pane according to claim 1 wherein the thermoplastic intermediate layer is formed from one or a plurality of thermoplastic films and the thermoplastic intermediate layer contains or is made of polyvinyl butyral (PVB), ethylene vinyl acetate (EVA), and/or polyurethane.

3. The composite pane according to claim 1, wherein the radar sensor is arranged embedded in the thermoplastic intermediate layer.

4. The composite pane according to claim 1, wherein the radar sensor is optically masked by a black print or a white print on the outer pane and/or on the inner pane.

5. The composite pane according to claim 1, wherein the radar sensor is operable for receiving radar data with a frequency bandwidth of at least 2 GHz and/or a frequency band of 76 to 150 GHz.

6. The composite pane according to claim 1, wherein the radar sensor has a detection range from 30 cm to 10 m.

7. The composite pane according to claim 1, wherein the radar sensor has a thickness of less than 1 mm.

8. The composite pane according to claim 1, wherein the radar sensor has a semiconductor chip that implements at least one radar transceiver.

9. The composite pane according to claim 8, wherein the semiconductor chip additionally implements a digital signal processing component and/or a control unit of the radar sensor, and/or the semiconductor chip and an antenna assembly of the radar sensor are implemented as a package and are integrated into the thermoplastic intermediate layer.

10. The composite pane according to claim 1, wherein the radar sensor and/or the evaluation unit is connected to onboard electronics and/or to a warning system of the vehicle or to an external output device for outputting a warning.

11. The composite pane according to claim 1, wherein the composite pane includes at least one further sensor and/or at least one further functional element.

12. A method for producing a composite pane according to claim 1 comprising:
providing a stack sequence composed of an outer pane, an inner pane, and at least one thermoplastic film arranged therebetween for forming the thermoplastic intermediate layer,
wherein at least one thermoplastic film includes at least one radar sensor or a radar sensor is arranged between the thermoplastic film and the outer pane and/or the inner pane, and
laminating the stack sequence to form a composite pane.

13. The method for producing a composite pane according to claim 11, wherein the radar sensor is form-fittingly inserted into a cutout in at least one thermoplastic film of the thermoplastic intermediate layer.

14. The method for producing a composite pane according to claim 11, wherein the radar sensor is connected to other sensors and/or to the onboard electronics via a CAN bus.

15. A method comprising providing a vehicle for traffic on land, in the air, or on water, with a composite pane according to claim 1.

16. The composite pane according to claim 11, wherein the thermoplastic intermediate layer includes said at least one further sensor and/or at least one further functional element.

17. The method according to claim 15, wherein the composite pane is a roof panel or a windshield.

18. The method according to claim 15, wherein the vehicle is a motor vehicle.
